(19) United States
(12) Patent Application Publication
(10) Pub. No.: US 2008/0027748 A1
(43) Pub. Date: Jan. 31, 2008

(54) Method and device for selecting data sets

(76) Inventor: Andreas Posmeck, Kassel (DE)

Correspondence Address: SILBER & FRIDMAN, 1037 ROUTE 46 EAST, SUITE 207, CLIFTON, NJ, 07013, US

(21) Appl. No.: 11/881,519

(22) Filed: Jul. 27, 2007

Related U.S. Application Data
(63) Continuation of application No. PCT/EP06/50492, filed on Jan. 27, 2006.

(30) Foreign Application Priority Data
Jan. 2, 2005 (DE) DE102005004 811.0

(51) Int. Cl. G06Q 50/00

(52) U.S. Cl. 705/1

(57) ABSTRACT

In a method for the selecting and displaying travel data information is read out. The data is digitalized and stored in a data set together with data containing information about their origin. Each data set is marked with an identification code. One or several selection criteria is then queried. A characterizing overview portion of the data sets is displayed in a hit list. A hit can be selected and the complete data set including pictures and texts are displayed. A parameter set with parameters is generated for the selected hit identifying the displayed data set. A data base search with a booking engine is then started and a hit list of trips available for booking is generated. The hit list is displayed on the same user interface as the complete data set.

This is a continuing application of PCT APPLICATION PCT/EP2006/050492 filed Jan. 27,2006 which claims priority of GERMAN PATENT APPLICATION DE 10 2005 004 811.0 filed Feb.. 1, 2005.

### FIELD OF THE INVENTION

The invention relates to a method for selection and display of travel data.

### BACKGROUND OF THE INVENTION

Generally, travel offers are provided in the form of catalogs. The travel organizer prints a catalog displaying the different accommodations with pictures and texts. The price of the trip can be acquired in a particularly complicated way from a separate price portion. The trip is then booked via a travel agency. The advantage of this approach is that all the trips of a region interesting for the customer are available in an appealing manner. Unfavorable, however, is the fact that the price is difficult to calculate. The production of the catalogs is complex and expensive. Moreover, the customer has no information about the availability of the trip. A price comparison with offers from different agents for the same accommodation can only be accomplished with much efforts.

On the web page ,,http://www.veranstalterkataloge.de/,, the otherwise printed catalog information of travels organizers was reproduced on the 25.1.2005. The web page mainly displays the catalogs. After selection of an organizer all corresponding catalogs are displayed. These can then be selected and leafed through. The scrolling is carried out like in a printed catalog by clicking the button ,,next hotel,,. In addition, the web page is provided with a small search engine, allowing the faster query of a certain hotel (or a round trip) according to the location, the name, or the organizer. Even here the customer obtains the actual travel data, especially information regarding availability and price, only in the travel agency.

Programs are known, which process the data within the corresponding price portions of the catalogs, and calculate and display the expected price for a trip.

In the internet trips are also offered which can be directly booked. So-called booking engines are applied for this purpose. They spare the way to the travel agency. A booking engine is a data base with currently available travel offers, which, together with a search engine, compiles offer lists for the customer. Thus, the booking engines only show offers that are actually available. At first the customer inserts information in an input form. Trips are then selected by the booking engine and displayed in a hit list. The combination with pictures and texts of a hotel is effected through the booking code of the organizer.

It is disadvantageous that the customer at first only obtains the travel data, like hotel name, travel destination, travel time, and price. Even a small attached picture is hardly adequate to improve the desire to book this trip. A pleasing impression, which will be generated for the customer when leafing through the catalog, is not generated by a booking engine. The customer will not obtain additional information and pictures until he clicks on the offer in the hit list. He obtains the information only after the data base search. Therefore, the customer will still incorporate travel catalogs in order to get inspirations before searching the data base and to get an impression of offered hotels.

### SUMMARY OF THE INVENTION

The invention relates to a method for the selection and display of travel data comprising the steps of:
(a) Reading information, especially pictures and text, associated with an accommodation at a travel destination from a catalog containing travel offers;
(b) Digitalizing the queried data;
(c) Storing the digitalized data in a data set together with data containing information about their origin;
(d) Marking the data set associated with an accommodation with an identification code;
(e) Repeating steps (a) to (d) for a plurality of accommodations, travel destinations and/or catalogs;
(f) Querying of one or more selection criteria;
(g) Reading and displaying a characterizing overview portion of one or more data sets selected according to the selection criteria;
(h) Selecting one of the displayed data sets, and
(i) Reading and displaying the complete, selected data set.
   With this method quasi a catalog page from a travel catalog is displayed on the computer.

It is an object of the invention to provide a method of the aforementioned kind, which allows animating the customer to select and book of a trip independently of the availability, and to quasi simultaneously offer available trips.

According to the invention this object is achieved by a method of the aforementioned kind comprising the steps of:
(j) Generating a parameter set with parameters clearly identifying the displayed data set,
(k) Starting a data base search with a booking engine considering the parameter set as selection criteria and the generating a hit list of trips available for booking, and
(l) Displaying the hit list on the same user interface as the complete data set.

Generally, travel data comprises specifications about the travel destination, e.g. a country or a region and a location within the country, as well as about the accommodation, e.g. a hotel name. Usually date specifications are also part of the travel data, i.e. departure date from hometown and a return date or the duration of the trip. Finally, a price and the organizer of the trip are part of the travel data.

Information about an accommodation at a travel destination from a catalog with travel offers can be photos of the hotel and descriptions of the location, the description, and other special features. Apart from this common information video sequences or similar information can be used to describe the hotel. Typically, in this information the accommodations are displayed in a particularly advantageous manner. The texts and pictures, therefore, promote the object. The term accommodation includes everything that is offered in travel catalogs. It includes all kinds of hotels, but also trips offering other kinds, for instance in pensions, tents, motor homes, etc., or even complete round trips.

If the information is available in an analog form, e.g. as a printout, they have to be digitalized. This can be accomplished by scanning, typing in, etc. The digitalized data are stored. The information can already be provided in digital form, e.g. as a print template. If necessary, the information can then be converted into a different format. In particular, the information can be assigned to categories. In this way, categories can be set up, like description, location, sports activities, room amenities, booking code, hotel category, etc.

Information about the origin of the data particularly comprises the organizer, the catalog name, and the booking code of the organizer. The digitalized data together with data, containing information about their origin, is then stored in a data set. Naturally, the physical storage can also be effected at different places and only a data set with a suitable link is generated. Instead of storing the pictures and texts for each data set also the address of the corresponding picture or text file can be stored. If required, the picture or text file can then be queried and displayed by means of the address stored in the data set.

Each data set is marked with an identification code. The identification code is part of the accommodation of the individual data set. Two data sets from different organizers for the same accommodation will then have the same identification codes, even with different booking codes. This is particularly useful since different names are often used for the same hotel in the catalogs.

For each catalog included in the data base the accommodations are processed. Accommodations, which are displayed in two different catalogs of the same organizer, are distinguished by their catalog name.

In general, the query for one or more selection criteria is accomplished via common input forms on the monitor of a personal computer. The computer can be connected via the internet or another network to the computer administrating the data base. Instead of an input it is also possible to obtain the selection criteria from a file, e.g. a stored profile or the like. In particular, organizer, catalog, country, region, city, and/or hotel name is queried. Even a full-text search is possible. The hits are displayed in a hit list. Provisions may be made to not only consider hits but also all other data sets having an identical identification code.

Only a characterizing overview portion of one or more data sets is displayed in the hit list. Such an overview portion may include the hotel name, the country, the organizer, and the hotel category. In addition, a miniaturized picture of the hotel can be displayed or attention can be drawn to special features.

A data set can be selected from the hit list, e.g., by a mouse click. For this data set the complete stored data are then displayed. The data shown reflect the information given in the organizer catalogs, including the pictures. Quasi a display of the catalog page of the selected hotel is obtained.

In order to book a trip for the selected hotel a parameter set is generated. The parameter set includes parameter clearly identifying the displayed data set. Such parameters are preferably the booking code of the organizer, the organizer name, and the session ID. A session, i.e. a visit of the web page where online catalogs are leafed through, obtains a unique identification attribute. This identification attribute is the so-called session ID. The session ID is transferred to the booking engine. Obviously, an abbreviation or a coding can be used instead of the name of the organizer as a parameter. Furthermore, the parameter set can also include the identification code. In some cases it is advantageous to include additional parameters, e.g. parameters for the identification of the user, the program from which the process was started, a start date, a tolerance around the start date, a trip duration, and parameters used to provide layout information.

After the generation of the parameter set a booking engine is activated. Such an booking engine can be physically located at a totally different place and operated by a different operator. Generally, the booking engine comprises one or more data bases with entries relating to trips available for booking. A trip available for booking comprises precise data about the date and the duration of the trip, airport of departure, hotel name, booking code, price, organizer, hotel category, and number of persons. The booking engine provides a search engine searching the data base, which provides suitable trips from the hit list according to the selection criteria.

In the present case, the search of the data base with a booking engine is effected taking into account the parameter set as selection criteria. Thus, in contrast to known booking engines, the hit list of trips available for booking is not only generated through inputs by means of an input form. In fact, the parameters generated by the hotel selection are also considered.

The hit list is then displayed on the same user interface as the complete data set. Obviously, the hit list can also be displayed in a new window. The display, however, always takes place in conjunction with the data set previously selected from catalog data containing pictures and texts. In such a way the customer obtains the possibility to leaf through a catalog for the first time and quasi learns about the concrete price of his trip at the same time. In addition, the customer directly gets to know whether the trip is available.

The approach to generate a data set, which is transferred to a separate booking engine, allows a particularly fast evaluation and display of the search results. The data base belonging to the booking engine must be updated at least daily. It comprises several million data sets. The search, therefore, takes some time. The maintenance and updating of the data base is complex. According to the present invention the booking engine can be completely independently designed. The same booking engine can be used by different user interfaces and organizers. However, the selection criteria must not be manually entered but they are automatically transferred in the form of a parameter set. It is particularly advantageous that both the detailed data regarding the hotel and the data regarding the price of the trip are displayed at the same time on a user interface or in a separate program. Thus, the catalog must not be placed next to the booking engine nor must the booking engine be operated at a different location, in order to get inspired. The otherwise complex calculation of the price is avoided. In the present invention the data regarding the price of the trip is provided by the booking engine. Due to the session ID the booking engine has the option to access already existing search results and inputs even for changes.

The booking engine can query additional selection criteria. This is accomplished by means of an input form. Selection criteria are, for example, departure and destination airport, start date, duration of the trip, number of persons or the hotel category. The booking engine can store such selection criteria afterwards. A new data base search with a new parameter set and the previously stored selection criteria can be started. Then, a new hit list is generated when a new data set, i.e. a new hotel, is selected.

Whenever a start date and duration of the trip, etc., is entered the booking engine can memorize these data. Recalling of the next data set, the booking engine obtains a new parameter set and evaluates available trips corresponding to the new parameter set and the various previous selection criteria.

Upon a suitable query the booking engine preferably covers the hit list with the data sets of all organizers. Therefore, not only trips are displayed, which are offered by the organizer of the actually displayed data set, but also available trips of additional organizers for the same accommodation. This approach allows, for example, a price comparison.

Different organizers often provide the same hotel with different names. The identification code, however, is the same for the hotel. The parameter set comprising the identification code provides the advantage that the booking engine can also display trips from other organizers without the need of a separate search for the same hotel. In such a way no hotels are neglected in the comparison.

Preferably, the hit list is sorted according to selection criteria. Such a selection criterion is, for example, the price.

Modifications of the invention are subject matter of the sub-claims. An embodiment is described below in greater detail with reference to the accompanying drawings.

### BRIEF DESCRIPTION OF THE DRAWING

Preferred embodiments of the invention will now be described, by way of example only, with reference to the accompanying diagrammatic figures in which:

FIG. 1 illustrates the initial user interface of a device for displaying travel catalog pages;

FIG. 2 illustrates the menu for entering selection criteria to select a specific hotel;

FIG. 3 illustrates a hit list from a characterizing overview portion of a data set for hotels corresponding to the selection criteria;

FIG. 4 illustrates the upper portion of a user interface, where information about a hotel is presented in detail;

FIG. 5 illustrates the lower portion of the user interface in FIG. 4 with a hit list of trips available for booking generated by a booking engine for an organizer;

FIG. 6 illustrates a hit list similar to the one in FIG. 5 but with hits for any organizers of the same accommodation; and

FIG. 7 illustrates a hit list for the same identification code.

### DETAILED DESCRIPTION OF THE INVENTION

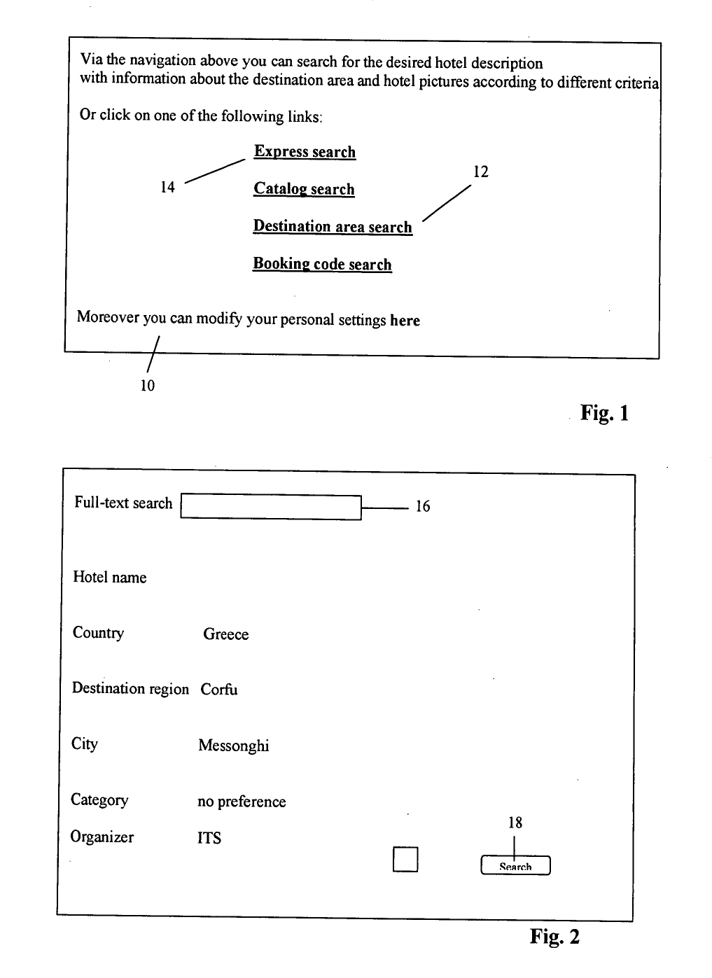

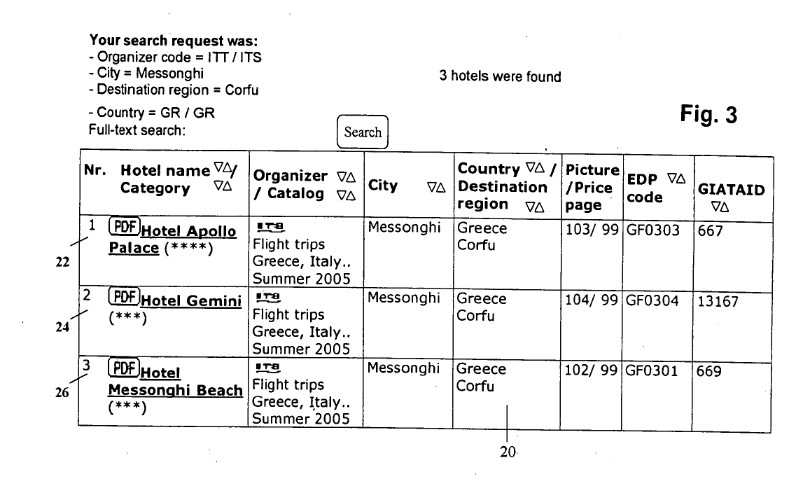

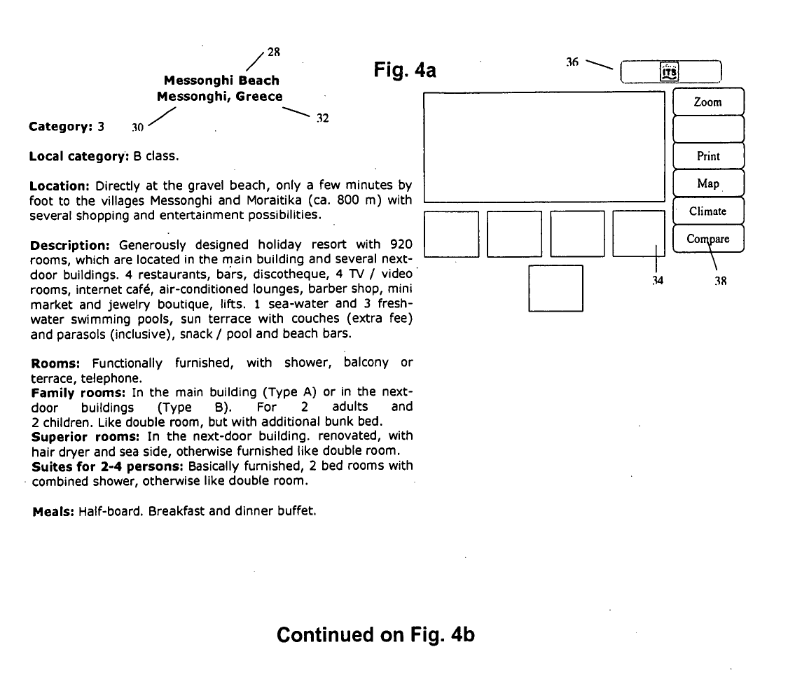

FIG. 1 illustrates a user interface 10 provided by a server. The user interface 10 is accessible in the common way by a browser via the internet. A start menu 12 is displayed on the user interface 10 allowing the search by means of different selection criteria. A first search option 14 is the ,,Express search”. In case of this option a menu appears, which is illustrated in FIG. 2. In the menu input fields 16 are provided. Inputs can be made for the hotel name, country, destination area, city, category, and organizer. The inputs for country, category, and organizer are accomplished by pull-down menus. The hotel name, the destination area, and the city can be entered via keyboard. Furthermore, an input field for a full-text search is provided. Entering data into these input fields and application of the button 18 ,,Search” the selection criteria are checked and a data base search is carried out. The hits are read out and displayed in a hit list. An example for such a hit list is illustrated in FIG. 3. A characterizing overview portion of the data sets is displayed in the hit list according to the selection criteria. In the present case, the overview portion comprises the hotel name, the hotel category, the organizer represented by a logo, the name of the organizer's catalog, the city, the country, and the destination region. Moreover, the page of the printed catalog is indicated whereon the hotel description can be found and the page of the price portion in the catalog. Finally, the booking code and an identification code for the queried hotel is indicated. The booking code is the code assigned by the organizer. The identification code is an organizer-independent code assigned only once for each hotel independent of its name.

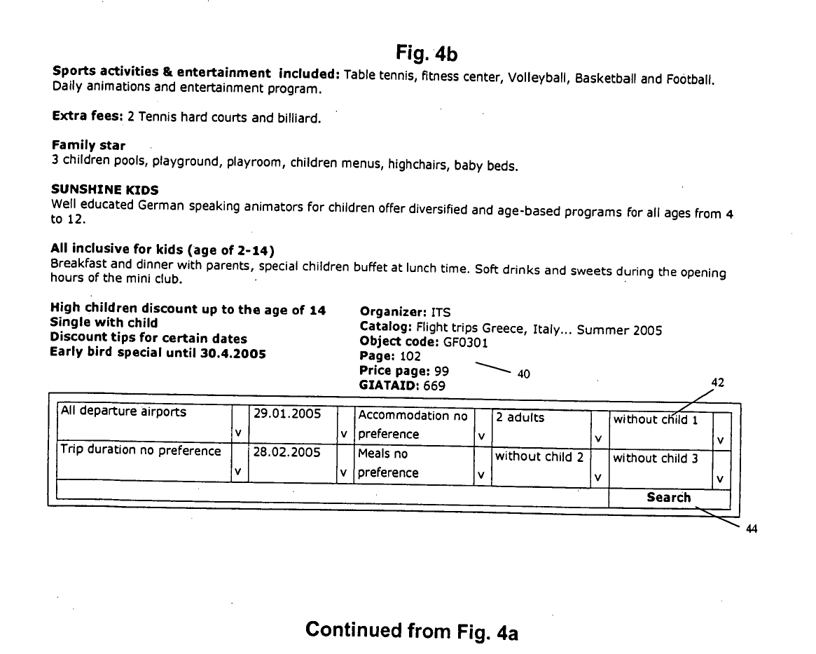

Each of the queried data sets fulfills the selection criteria of the inputted selection criteria in the input form in FIG. 2. From the displayed hits of the hit list 20, one of the data sets 22, 24 or 26 can be selected. This is accomplished by a mouse click on the hotel name. All picture and text data of the selected data set are read and displayed on the monitor. Thus, the complete data set is now displayed. An example of such a data set is illustrated in FIG. 4.

The data set comprises the hotel name 28 in the title, the destination area 30, and the travel country 32. Furthermore information is provided in the following categories: hotel category, country category, location, description, rooms, meals, sports activities and entertainment, family and discount options.

Moreover, pictures 34 can be found just like in a catalog. The logo 36 is an indication of the organizer. Additional information about climate and geographical location can be obtained via a menu 38.

A summary of the data for this object, i.e. for the hotel, is located in a field 40. Here, the organizer abbreviation, the catalog from which the data were taken from, the object code, the catalog page, the price page, and the identification code are displayed. These data essentially correspond to the characterizing overview portion.

An input menu for a booking engine is provided on the same side of the catalog image in FIG. 4. The layout of the input menu is adapted to layout of the display of the digital catalog page. Upon the selection of a hotel a parameter set is generated, which is provided at an interface for a booking engine. The parameter set essentially comprises the data 40. In the following example they are:
Session ID of the user
ID of the user
Identification code of the offer
Organizer code, i.e. an abbreviation representing the organizer
Booking code of the organizer
Program code to enable the booking engine to recognize the program providing the parameter set
Start date of the trip in the form of a default value
Tolerance around the start date in the form of a default value
Duration of the trip in the form of a default value
File name for the adaptation of the design to an Iframe.

The booking engine can use the parameters of the parameter set as inputs for initialization. These parameters are displayed at first in the input form 42. The data set is adapted to be completely identified by the parameter set. In addition to the compulsory data for identification, some default values are entered into the booking engine in order to simplify and speed-up the input.

In the booking engine values like, room specification, number of adults, departure date, departure airport, etc., can be set. For each subsequent hotel query during a session the customer can find the preset values in the same way. This can be realized by the booking engine on the basis of the always available session ID used to enable the booking engine to identify the session and upload the corresponding settings.

The design of the booking engine is adapted to the design of the rest of the display. Since the booking engine is embedded via Iframe in the different designs, the booking engine is optically adapted to the respective design by means of a CSS file. The name of the CSS file is transferred as a parameter to the booking engine. The booking engine assemble the full address and recall the file by means of this address fragment.

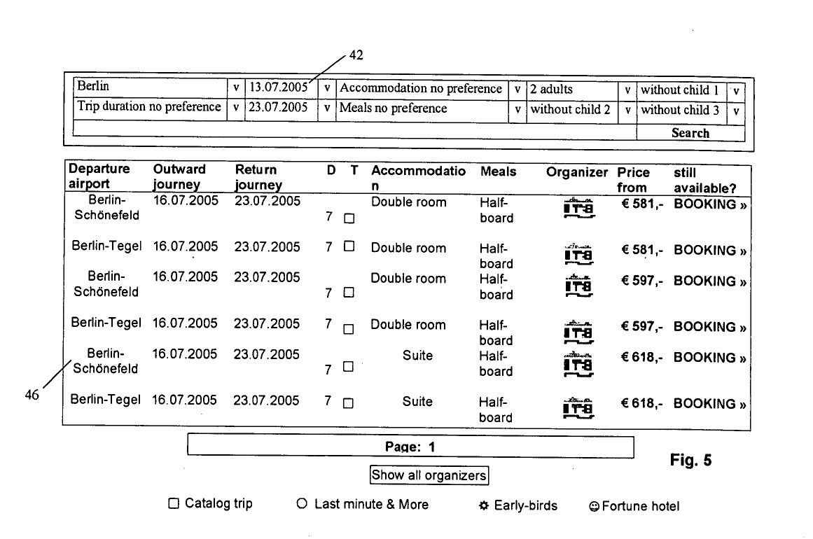

In such a way the booking engine becomes an integral part of the user interface. The user obtains a hit list by entering the selection criteria in the form 42 and starting the search with the button 44. Such a hit list is illustrated in FIG. 5. The hit list is displayed directly below the input form on the same page as the hotel details and the input form. In the present example, the hit list is illustrated separately only for the purpose of better illustration. The departure airport and the departure date were modified in the input form 42. The organizer, whose catalog page (FIG. 4) is actually displayed, then obtains a hit list 46 with 7 hits.

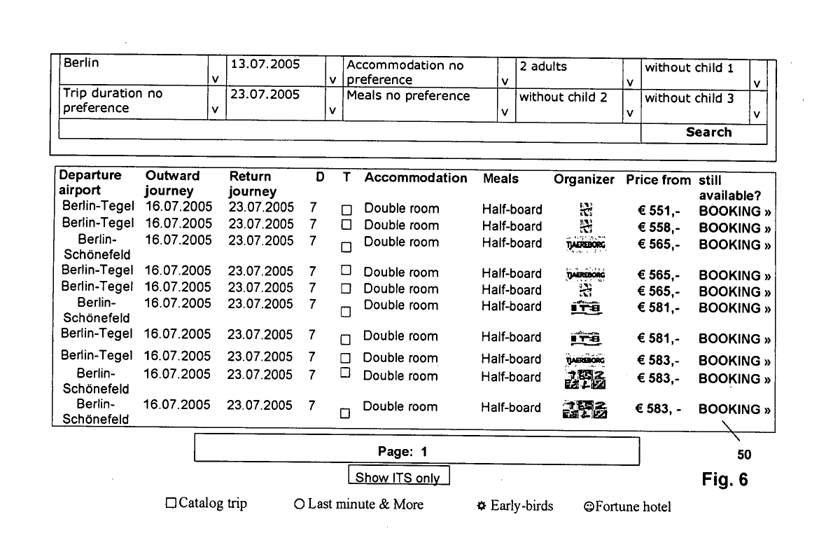

By clicking the button 48 all trips in the same accommodation are displayed independently of the organizer fulfilling the selection criteria in the required way. This is illustrated in FIG. 6. The trips shown are not gathered from a catalog for which the price was calculated from the price portion. In fact they are the result of a data base search, where the availability is also guaranteed. Thus, the hit list does not represent a computer-automated, improved price portion of the catalog but is a particular link to the actual booking. The booking can be started by a click on the button 50. Then the usual formalities, like payments etc., are arranged for the internet purchase.

It is an essential part of the present approach to enable a price comparison for the same hotel and to check the availability in real time. The details of FIG. 4 are displayed during the entire input procedure. A confusion of the booked hotel, e.g. due to similar-sounding or foreign names, is avoided.

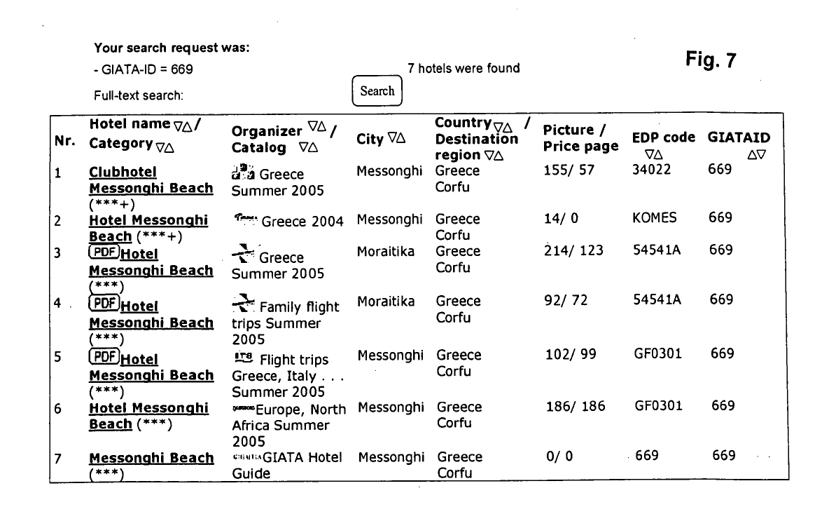

Since each organizer includes his own texts and pictures into his catalog, a comparison of the different illustrations is possible by means of the button ,,Compare” in the menu 38 of FIG. 4. The search is started upon activation of this button. The hit list is illustrated in FIG. 7. All data sets with the same identification code are defined by the search as hits. In the present case, 7 hits were found for the identification code 669. It can be seen that the hits with the numbers 3 and 4 have the same organizer and organizer code (EDP code). The data sets, however, originate from different catalogs and possibly have a different hotel description.

As from the hit list in FIG. 3 the desired, detailed hotel description is now downloaded via a mouse click.

Again, the input form of the booking engine provides this hotel description. The input form, however, is already filled in with the previously made inputs. Unless the user does not want to modify his inputs he consequently does not need to make additional inputs or to activate the booking engine. Without additional input the booking engine selects all offers and displays them in a hit list along the lines of FIGS. 5 and 6.

When a hotel was selected by means of the menu item ,,Catalog search” in the main menu 12 of FIG. 1, a button ,,next hotel” is displayed together with the complete data. By consecutive activation of this button the selected catalog can be leafed through page per page. Without additional activation the booking engine displays the travel offers, which are available for the desired travel period and the desired number of people. Therefore, the hotel- and organizer-related parameter are changed and transferred via the interface to the booking engine, but the selection criteria for the trip remain constant and are memorized using the session ID.

The search for a hotel can be supported by a full-text search. For this purpose an input field is provided in the menu of FIG. 2. In case of a full-text search the entire data base is scanned.

What is claimed is:

1. A method for selection and display of travel data comprising the steps of:
(a) reading a unit of travel information, thereby generating travel data; said travel information having a characterizing overview portion forming a part of the complete travel information;
(b) digitalizing said travel data thereby generating digitalized travel data;
(c) storing said digitalized travel data in a data set together with data containing information about their origin;
(d) marking said data set with an identification code;
(e) repeating steps from (a) to (d) for a plurality of said units of travel information;
(f) carrying out a query with one or more selection criteria;
(g) obtaining and displaying said characterizing overview portion of one or more of said data sets selected according to said selection criteria;
(h) selecting one of the data sets having said characterizing overview portion displayed;
(i) reading and displaying said complete information of said selected data set;
(j) generating a parameter set with parameters clearly identifying said displayed data set;
(k) starting a data base search with a booking engine considering said parameter set as selection criteria and generating a hit list of trips available for booking; and
(1) displaying said hit list on a user interface, said user interface being the same user interface where the complete data set is displayed.

2. A method according to claim 1, wherein said parameter set comprises a booking code of an organizer, an organizer name of said organizer, and a session ID.

3. A method according to claim 2, wherein said parameter set comprises an identification code.

4. A method according to claim 3, wherein said booking engine carries out a query with additional selection criteria, stores them and starts a new data base search with a new parameter set and the previously stored selection criteria, and generates a new hit list in case a new data set is selected.

5. A method according to claim 1, wherein said booking engine extents said hit list to data sets of all of said organizers on request.

6. A method according to claim 1, wherein said hit list is sorted according to sorting criteria, said sorting criteria being adapted to be selected.

7. A method according to claim 1, whereby said unit of travel information comprises pictures and text.

8. A method according to claim 7, wherein said pictures and text are associated with accommodations for a travel destination from a catalog containing travel offers.

9. A method according to claim 8, wherein in said step (e), said steps from (a) to (d) are repeated for plurality of accommodations, travel destinations and catalogs.

10. A device for selection and display of travel data, comprising:
(a) means for reading travel information, thereby generating travel data; said travel information having a characterizing overview portion forming a part of the complete travel information;
(b) digitalization means for digitalizing said travel data thereby generating digitalized travel data;
(c) means for storing said digitalized travel data in a data set together with data containing information about their origin;
(d) means for marking said data set with an identification code;
(e) query means for carrying out a query with one or more selection criteria;
(f) means for obtaining and displaying said characterizing overview portion of one or more of said data sets selected according to said selection criteria;
(g) means for selecting one of the data sets having said characterizing overview portion displayed;
(h) means for reading and displaying said complete information of said selected data set;
(i) means for generating a parameter set with parameters clearly identifying said displayed data set;
(j) means for starting a data base search with a booking engine considering said parameter set as selection criteria and generating a hit list of trips available for booking, and
(k) means for displaying said hit list on a user interface, said user interface being the same user interface where the complete data set is displayed.

11. A device according to claim 10, wherein said travel information comprises pictures and text associated with an accommodation at a travel destination.

12. A device according to claim 11, wherein said travel information is obtained from a catalog containing travel offers.
